(19) United States
(12) Patent Application Publication
(10) Pub. No.: US 2014/0001227 A1
(43) Pub. Date: Jan. 2, 2014

(54) CARTON CLOSING TOOL HAVING TOOL-FREE ADJUSTMENT MEMBERS

(71) Applicant: STANLEY FASTENING SYSTEMS, L.P., North Kingstown, RI (US)

(72) Inventors: Brian McNeill, Warwick, RI (US); Jonathan D. Kalow, East Greenwich, RI (US)

(21) Appl. No.: 13/844,785

(22) Filed: Mar. 15, 2013

Related U.S. Application Data
(60) Provisional application No. 61/665,744, filed on Jun. 28, 2012.

(51) Int. Cl. B25C 5/16

(52) U.S. Cl. CPC B25C 5/1606
USPC 227/120

(57) ABSTRACT

Tool-free adjustment members in a fastener driving tool. The fastener driving tool can be used to seal closed containers such as, for example, corrugated fiberboard cartons, by applying staples to the folded flaps or other closure parts to secure them in place. The tool-free adjustment members provide customizable drive settings for a variety of different sized staples and different workpiece conditions.

### CROSS-REFERENCE TO RELATED APPLICATIONS

This application claims the benefit of priority from U.S. Provisional Patent Application No. 61/665,744, filed on Jun. 28, 2012, the content of which is incorporated by reference in its entirety.

### FIELD

This invention relates to fastener driving tools and more particularly to fastener driving tools including clinching mechanisms.

### BACKGROUND

Power operated fastener driving tools are traditionally used in industrial applications where compressed air provides a convenient power source. Because of the nature of the compressed air power source and the expense involved in heavy duty industrial fastener driving tools, such tools are generally not suitable for use in fastening jobs where maneuvering is required, space is limited, or compressed air is not available. Manually operated fastener driving tools are also used in industrial applications. However, in many of the jobs where manually operated fastener driving tools are used, considerable operator fatigue may be involved because a manual fastener driving tool requires a large user actuation force.

### SUMMARY

A carton closing tool of the embodiments herein includes adjustment members that adjust the tool to accommodate various staple sizes and tool drive characteristics without requiring the use of hand tools. The present invention incorporates these tool free adjustment members in a stapling tool for blind fastening of cardboard, typically packing boxes. Tools of this type contain a set of two movable anvils as part of a mechanism, such that when a staple is driven, the anvils penetrate the cardboard workpiece to clinch the staple legs and are subsequently automatically retracted.

Packaging tools commonly include different adjustment devices that can affect at least one of the following: the staple leg length accepted by the tool, the tightness of the clinch, and the depth of drive. Most existing adjustment members require hand tools to actuate the adjustment members. In the embodiments described herein, the same adjustments can be made with the novel adjustment members of the present invention that do not require hand tools for adjustment.

According to an aspect of the invention, there is provided fastener driving tool, comprising: a housing; a drive track within the housing; a magazine connected to the housing and configured to hold a supply of fasteners and to provide a leading fastener to the drive track; a driver configured to move downward in the drive track and drive the leading fastener into a workpiece during a drive stroke, and upward in the drive track during a return stroke; a mount connected to the driver; a clinching assembly operatively connected to the housing and to the mount, the clinching assembly being configured to engage the leading fastener during the drive stroke and move into a clinching position at the end of the drive stroke to clinch the fastener to the workpiece; and an adjuster configured to adjust the clinching assembly to accommodate fasteners having different lengths.

### BRIEF DESCRIPTION OF THE DRAWINGS

The numerous advantages of the present invention may be better understood by those skilled in the art by reference to the accompanying figures. In the drawings, like reference numerals designate corresponding parts throughout the several views.

FIG. 1 illustrates an exemplary fastener driving tool constructed in accordance with the teachings of the present disclosure;

FIG. 2 illustrates a cross-sectional view of the fastener driving tool of the embodiment of FIG. 1;

FIG. 3 illustrates the fastener closing mechanism of the embodiment of FIG. 1 in the open position;

FIG. 4 illustrates the fastener closing mechanism of the embodiment of FIG. 1 at the beginning of actuation;

FIG. 5 illustrates the fastener closing mechanism of the embodiment of FIG. 1 in the closed position;

FIG. 6 illustrates a cross-sectional view of the clinching mechanism in the upstroke position;

FIG. 7 illustrates a cross-sectional view of the clinching mechanism in the downstroke position;

FIG. 8 illustrates a front view of the driving and clinching mechanisms with the leg length adjustment for a first leg setting;

FIG. 9 illustrates a front view of the driving and clinching mechanisms with the leg length adjustment for a second leg setting;

FIG. 10 illustrates a front view of the leg length adjustment cam lobes for a first leg setting;

FIG. 11 illustrates a front view of the leg length adjustment cam lobes for a second leg setting;

FIG. 12 illustrates a front view of the driving and clinching mechanisms with the clinch adjustment knob in a first setting;

FIG. 13 illustrates a front view of the driving and clinching mechanisms with the clinch adjustment knob in a second setting;

FIG. 14 illustrates a cross-sectional view of the driving and clinching mechanisms with the clinching mechanism with the clinch adjustment knob in a first setting;

FIG. 15 illustrates a cross-sectional view of the driving and clinching mechanisms with the clinching mechanism with the clinch adjustment knob in a second setting ;

FIG. 16 illustrates a rear cross-sectional view of the tool in a first depth of drive adjustment position; and

FIG. 17 illustrates a rear cross-sectional view of the tool in a second depth of drive adjustment position,

### DETAILED DESCRIPTION OF THE INVENTION

Reference will now be made in detail to the present embodiments of the invention, examples of which are illustrated in the accompanying drawings,

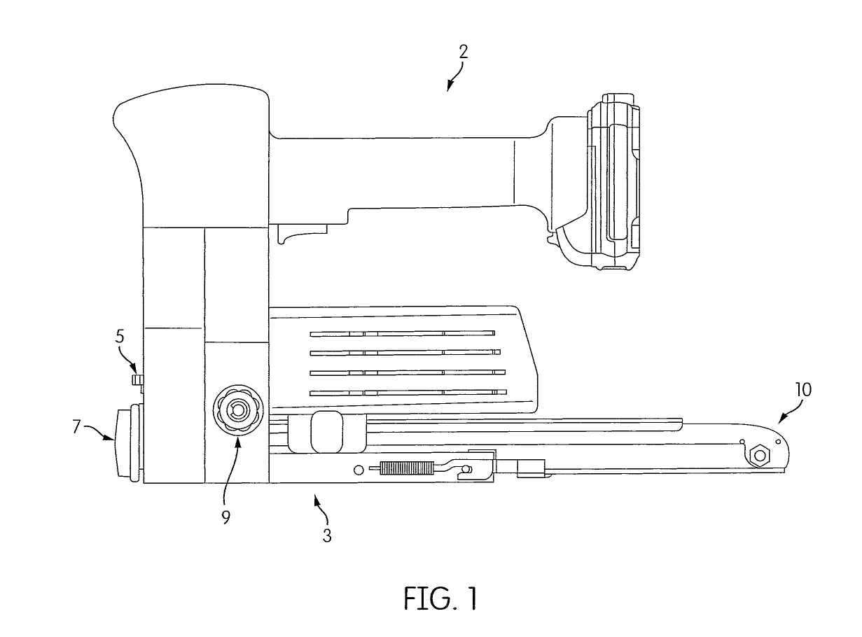

FIG. 1 illustrates an embodiment of the fastener driving or carton closing tool. Attaching to the tool body 2 is a removable magazine 10 which stores the fasteners, such as staples, prior to driving, and a tool base 3 that contacts the workpiece surface during use.

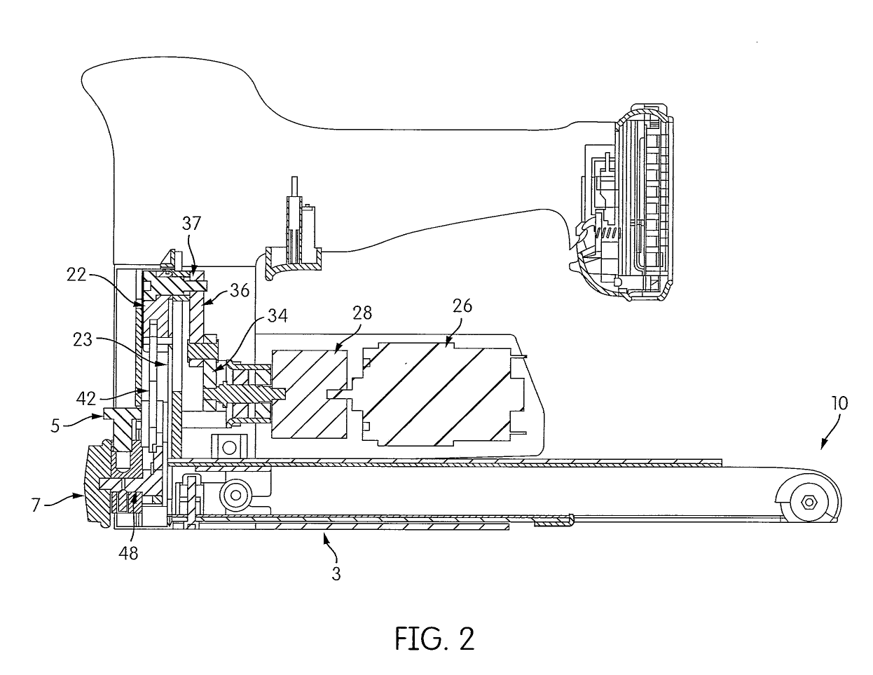

As shown in FIGS. 1 and 2, the tool includes a variable clinch adjustment thumbwheel 5 that controls the downstroke position of the clincher arms in the clinching assembly of the tool. The variable clinch adjustment thumbwheel 5 has a gripping surface with grooves that allow the user to securely grasp the thumbwheel. By turning the thumbwheel, in a first direction or a second direction, the tool increases or decreases the space between the clinching arms in the downstroke, and thereby increases or decreases the tightness of the formed staple legs.

Another adjustment member is a positionable leg length adjustment dial 7. The dial 7 is rotatable and changes the pivot axis of the clincher arms of the clincher assembly between a first setting for a staple having a first length to a second setting for a staple having a second length without the use of hand tools.

A further adjustment member is a depth of drive dial 9. The depth of drive dial rotates between a range of positions to change how deep the staple can be fired to penetrate the workpiece.

FIG. 2 shows a cross-sectional view of the tool illustrating the crank arm 34 and the motor 26 that provides power to the tool for driving the staple. Power from the motor is transferred through a gear reduction mechanism 28 to a crank arm 34 and connecting rod 36. The connecting rod 36 is linked to a driver mounting block 22, on which is mounted the driver blade 23 and a clincher linkage 42 of a clinching assembly 40.

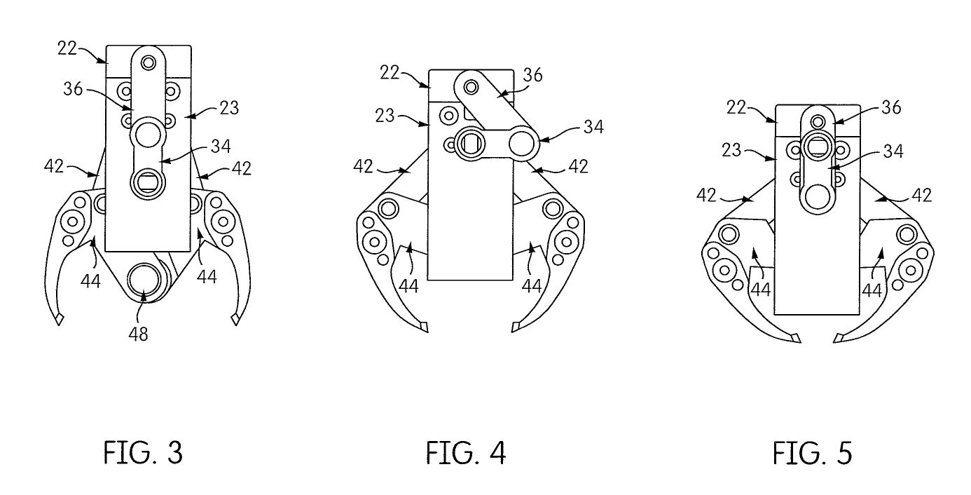

FIGS. 3, 4, and 5 show the driving assembly and fastener closing mechanism in the form of a clinching assembly that drives and clinches, respectively, the staple into the workpiece. FIG. 3 shows the driving assembly in the upstroke position where the clinching assembly is in the open position. FIG. 4 show the progression of the driving and clinching assemblies and how they move toward the downward stroke. FIG. 5 illustrates the driving assembly in the downward stroke wherein the clinching assembly is positioned to be closed around a staple.

The crank arm 34 rotates using power provided by the motor 26 to the gear reduction mechanism 28. Rotation of the crank arm 34 pulls and pushes a connecting rod 36 around an upper pivot pin 37, which translates the circular motion of the connecting rod into the linear reciprocating motion of a driver mounting block 22, which may be referred to as a mount. The driver mounting block 22 is linked to the driver blade 23, which pushes the staple into the workpiece. In an embodiment, the driver mounting block 22 may be integral with the driver blade 23. The driver mounting block 22 additionally pushes a pair of clincher linkages 42 in an outward direction away from the driver mounting block. At the end of each clincher linkage is a clincher arm that is pivotable about a pivot pin 48 on the clincher linkage 42. The pivotable movement of the clincher arm forces clincher anvils 46 toward each other to close the clinching assembly around the staple forcing the staple legs to bend toward each other to close the staple in position within the workpiece.

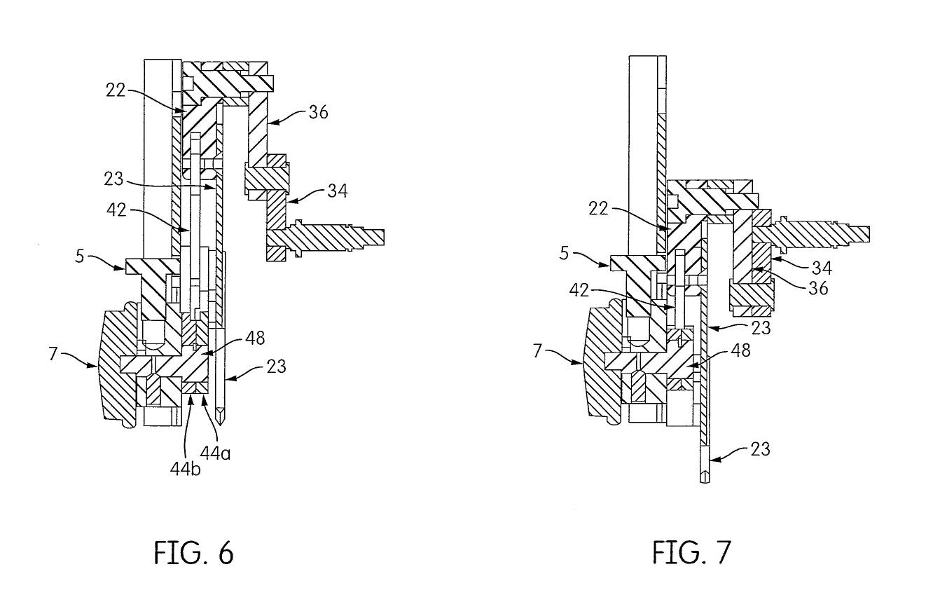

FIGS. 6 and 7 show the driving and clinching mechanism in a cross-sectional view, During operation, the crank arm 34 is rotated by the output shaft of the motor gearbox. The crank arm pulls a connecting rod 36, which translates the rotation into a linear reciprocating motion of a driver mounting block 22. The driver mounting block in turn pushes the driver 23, which pushes the staple into the workpiece. The driver mounting block additionally pushes two clincher linkages 42 which in turn rotate two clincher arms 44 about a pivot pin 48 in order to clinch the staple legs.

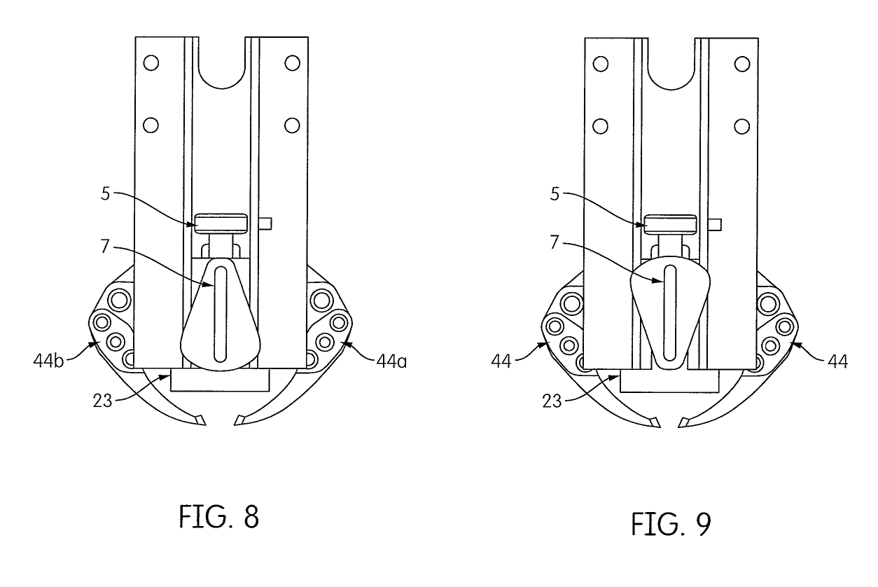

FIGS. 8 and 9 show the driver blade 23 and clincher arms 44, namely clincher arm 44a and clincher arm 44b, at the bottom of the drive stroke in two different positions for driving staples of different leg lengths. In FIG. 8, the leg length adjustment dial 7 is set in a first setting for a first length staple leg. In FIG. 9, the leg length adjustment dial 7 is set in a second setting for a second length staple leg. In an embodiment, the first length staple can be shorter than a second length staple. Alternatively, in an embodiment, the first length staple can be longer than the second length staple. Long leg staples have legs that longer than the short leg staples, and allow for deeper penetration into thicker workpieces. The leg length adjustment dial 7 controls the depth of the clinch to accommodate workpieces of different thicknesses by changing the centers of rotation for the clincher arms 44, within the tool, to be closer to the workpiece. Accordingly, when the user turns the leg length adjustment dial 7 by hand, the dial 7 rotates the lower pivot pin 48 180-degrees, which changes the centers of rotation for the clincher arms 44 vertically and horizontally via two cam lobes 56, 58 on the pivot pin 48. In the long leg setting, the clincher anvils 46 extend deeper into the workpiece and come closer to each other than in the short-leg setting as a result of the centers of rotation moving lower and horizontally towards the opposite clincher arms 44.

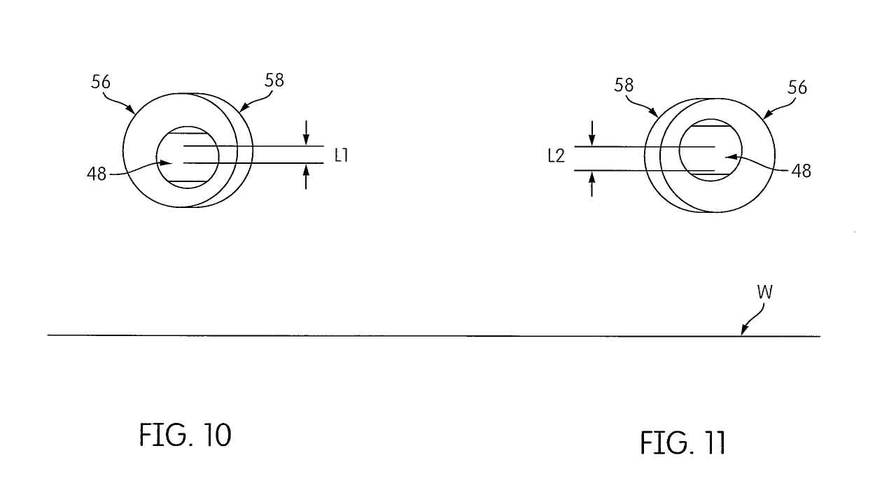

FIGS. 10 and 11 further show the leg length adjustment mechanism described above. In FIG. 10, the pivot pin 48 is in a long leg setting. In FIG. 11, the pivot pin 48 is in a short leg setting. The pivot pin 48 has two cam lobes 56, 58. The cam lobes 56, 58 serve as the centers of rotation for the clincher arms 44, which clinch the staple during tool actuation. In FIG. 10, the cam lobes 56, 58 are disposed at a position higher in the tool, that is, further from the workpiece than the pivot pin 48. The axes L1 of the cam lobes are therefore higher than the axis of the pivot pin in FIG. 10. Each on the respective side of its mating clincher arm 44a, 44b. This causes the clincher arms 44a, 44b to be positioned further within the tool with respect to the workpiece and further apart at the conclusion of the downstroke. In FIG. 11, the cam lobes 56, 58 are shown at a 180 degree difference from that of FIG. 10, The cam lobes in FIG. 11 are lower in the tool, that is, closer to the workpiece than the pivot pin, The axes L2 of the cam lobes are therefore lower than the axis of the pivot pin in FIG. 11. Accordingly, the clincher arms are closer together at the conclusion of the downstroke.

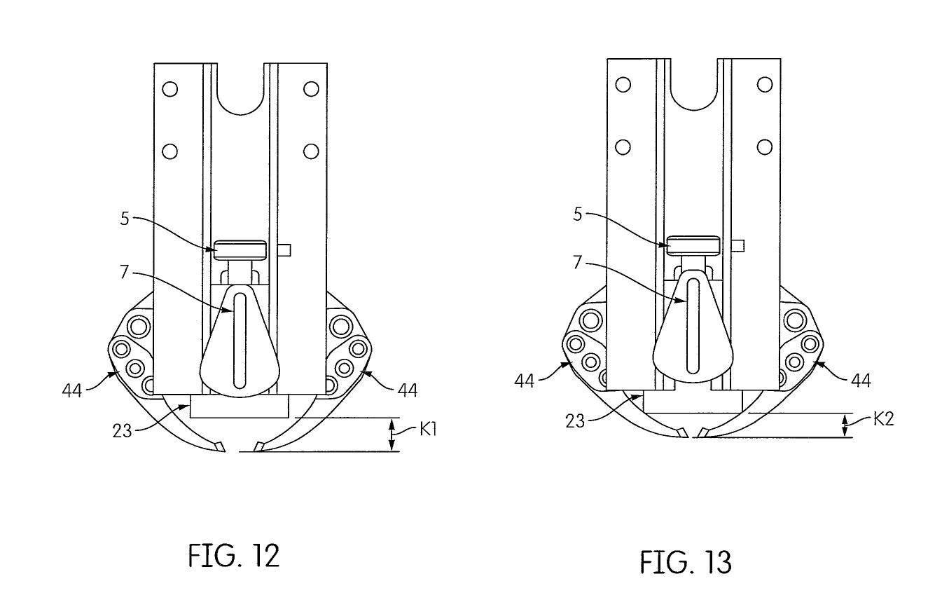

FIGS. 12 and 13 show the driver blade 23 and clincher arms 44 at the bottom of the drive stroke as the clinch tightness adjustment is made. FIG. 12 shows the clinch adjustment knob 5 set to a loose clinch, and FIG. 13 shows the knob set to a tight clinch. When the user rotates the clinch adjustment thumbwheel, the lower pivot pin 48 is moved vertically, which in turn moves the centers of rotation for the clincher arms 44 vertically. The effect of this movement is that, at the bottom of the drive stroke, the clincher arms 44 are closer to the driver blade 23 by a distance K2, and the clincher anvils 46 are closer together in FIG. 13 as compared to FIG. 12, where the clincher arms are farther from the driver blade by a distance K1.

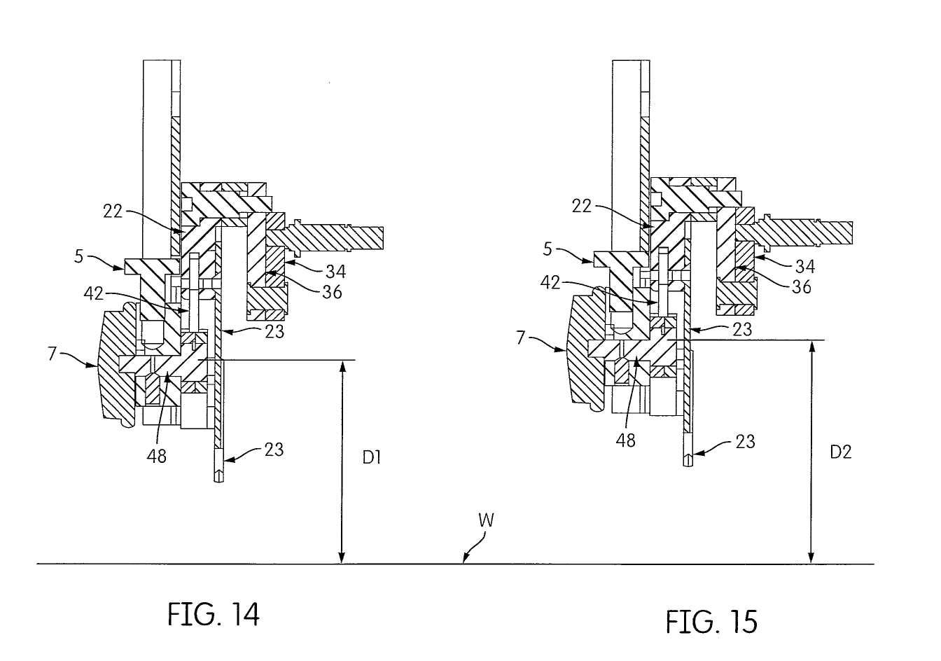

FIGS. 14 and 15 show the clinch adjustment in a loose setting and tight setting, respectively. In a loose setting, at the bottom of the drive stroke, the clincher arms are farther apart from each other than in a tight setting where the clincher arms are closer to each other. The pivot pin 48 and the clinch adjustment thumbwheel 5 are moved. In FIG. 15, the pivot pin 48 is positioned higher in the tool, that is, a distance D2 that is further from the workpiece, as compared to distance D1 in FIG. 14. The placement of the pivot pin farther away from the workpiece causes the clincher arms 44 to pivot further inward, thus coming closer to each other during the clinching of the staple and closer to the driver blade 23 than the arrangement of the clincher arms 44 in FIG. 14.

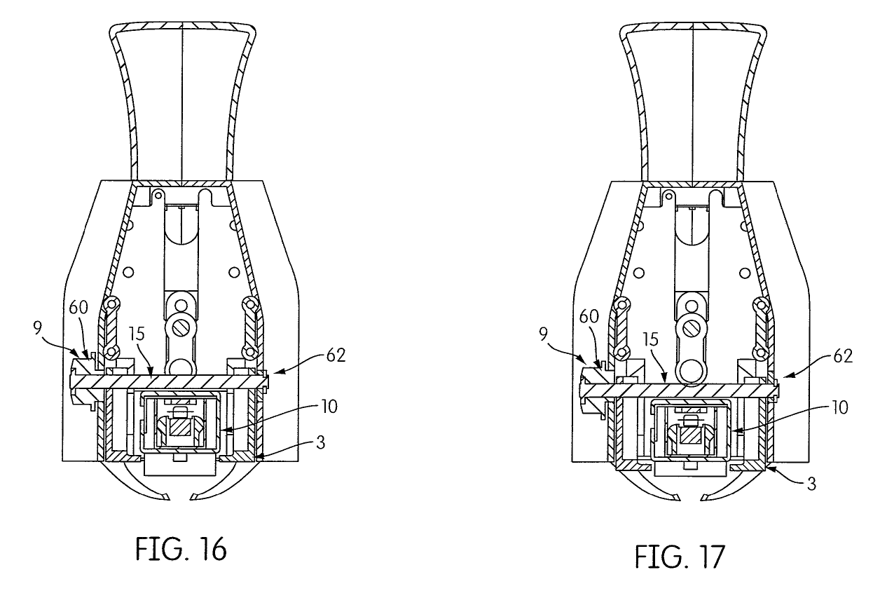

FIGS. 16 and 17 show the tool from the rear in a cross-sectional view as the depth of drive adjustment is made. The depth of drive adjustment dial 9 is rotated by hand, which turns a drive adjustment shaft 15. The drive adjustment shaft 15 turns a pair of depth of drive cam lobes 60, 62 on each side of tool which raises and lower the housing 4 of the tool. As shown in FIG. 16, the depth of drive cam lobe 60 is integral with the depth of drive dial 9. Alternatively, the cam lobe 60 can be separate from the dial 9. The depth of drive cam lobe 62 is located at an opposite side of the shaft 15. Raising and lowering of the housing 4 of the tool also moves the motor-gear reduction housing, the driving assembly and the clinching assembly vertically with respect to the staple magazine 10 and base 3.

The fastener driving device described here represents an improvement over stapling machines of the movable anvil type which typically require tools for the adjustment of staple size or drive characteristics. The device contains features for adjustment of the staple leg length, clinch tightness, and depth of drive which can be operated in the absence of tools.

Furthermore, while aspects of the present invention are described herein and illustrated in the accompanying drawings in the context of a fastening tool, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A fastener driving tool, comprising:
a housing;
a drive track within the housing;
a magazine connected to the housing and configured to hold a supply of fasteners and to provide a leading fastener to the drive track;
a driver configured to move downward in the drive track and drive the leading fastener into a workpiece during a drive stroke, and upward in the drive track during a return stroke;
a mount connected to the driver;
a clinching assembly operatively connected to the housing and to the mount, the clinching assembly being configured to engage the leading fastener during the drive stroke and move into a clinching position at the end of the drive stroke to clinch the fastener to the workpiece; and
an adjuster configured to adjust the clinching assembly to accommodate fasteners having different lengths.

2. The fastener driving tool according to claim 1, wherein the clinching assembly comprises:
a first link pivotably connected to the mount, and a second link pivotably connected to the mount;
a first clincher arm pivotably connected to the first link and pivotably connected to the housing, and a second clincher arm pivotably connected to the second link and pivotably connected to the housing; and
a first clincher anvil connected to the first clincher arm at a first end thereof, and a second clincher anvil connected to the second clincher arm at a first end thereof, wherein a second end of the first clincher anvil and a second end of the second clincher anvil are each configured to move downwardly and inwardly towards each other to engage the leading fastener during the drive stroke and clinch the leading fastener to the workpiece at the end of the drive stroke.

3. The fastener driving tool according to claim 2, wherein the fasteners are staples, wherein each staple comprises a crown and two legs extending from the crown, and wherein the driver is configured to engage the crown and each of the second ends of the first and second clincher anvils is configured to engage one of the legs.

4. The fastener driving tool according to claim 3, wherein the adjuster comprises an adjustment dial configured to be rotated to a first setting for a first length leg of a staple to be driven by the driver and clinched by the clinching assembly, and to be rotated to a second setting for a second length of a staple to be driven by the driver and clinched by the clinching assembly.

5. The fastener driving tool according to claim 4, wherein rotation of the adjustment dial changes centers of rotation of at least one of the first clincher arm and the second clincher arm.

6. The fastener driving tool according to claim 2, wherein the first clincher anvil and the second clincher anvil each have an arcuate shape and extend arcuately downwardly from the respective second ends of the first clincher arm and the second clincher arm.

7. The fastener driving tool according to claim 6, wherein a distal tip of the first clincher anvil and a distal tip of the second clincher anvil are each configured to pierce through the workpiece as the first clincher anvil and the second clincher anvil move downwardly and inwardly into the clinching position.
